(19) United States
(12) Patent Application Publication
(10) Pub. No.: US 2025/0040735 A1
(43) Pub. Date: Feb. 6, 2025

(54) Plant-Protecting Pot Device

(71) Applicant: Troy Wegner, Franklin Grove, IL (US)

(72) Inventor: Troy Wegner, Franklin Grove, IL (US)

(21) Appl. No.: 18/464,331

(22) Filed: Sep. 11, 2023

Related U.S. Application Data
(60) Provisional application No. 63/517,639, filed on Aug. 4, 2023.

(51) Int. Cl. A47G 7/08; A01G 13/04

(52) U.S. Cl. CPC A47G 7/08; A01G 13/04

(57) ABSTRACT

A plant-protecting pot device is provided. The device is comprised of a plant-protecting pot device comprised of a pot that can be used to store a plant. The pot is comprised of a rim comprised of at least one fastener. At least one base of the device is comprised of at least one barrier that is generally conical. The base is comprised of at least one fastener that can be attached to the fastener of the rim. As a result, the barrier surrounds a plant within the pot while the plant grows. The barrier protects the plant from animals, weather, and other damage.

### CROSS-REFERENCE TO RELATED APPLICATION

The present application claims priority to, and the benefit of, U.S. Provisional Application No. 63/517,639, which was filed on Aug. 4, 2023, and is incorporated herein by reference in its entirety.

### FIELD OF THE INVENTION

The present invention relates generally to the field of planting and gardening. More specifically, the present invention relates to a plant-protecting pot device that provides a plant pot and attachable barrier that encloses a plant growing inside the pot and wherein the barrier protects the plant from animals and weather while growing. Accordingly, the present disclosure makes specific reference thereto. Nonetheless, it is to be appreciated that aspects of the present invention are also equally applicable to other like applications, devices, and methods of manufacture.

### BACKGROUND

Individuals may grow vegetables, flowers, and other plants in five-gallon buckets as it provides a flexible, portable, and cost-effective solution for gardening, especially in urban areas with limited space. This approach is particularly popular among urban dwellers who do not have access to a garden or allotment. However, as plants grow upward and out of the bucket, they become increasingly exposed and vulnerable to various external threats. For example, animals such as deer, rabbits, or squirrels may be attracted to the plants and can cause significant damage by eating the leaves, flowers, or fruits. Additionally, inclement weather conditions like heavy rain, hail, or strong winds can also pose a serious threat to the plants' well-being, potentially breaking stems, washing away the soil, or causing other forms of physical damage.

To counter these risks, people may try to apply makeshift barriers or wires around the plants. For instance, they might construct a rudimentary fence out of chicken wire or netting, or set up a barrier made of wood or plastic. However, securing these barriers properly can be quite challenging, especially if the person does not have the necessary tools, materials, or skills. Often, these makeshift solutions may not be robust enough to withstand the external pressures they are meant to protect against, leading to the plants getting damaged despite the efforts made to protect them. Moreover, setting up such barriers may also inadvertently limit the plants' access to sunlight, air, and rain, which are essential for their growth and development.

In conclusion, while growing plants in five-gallon buckets provide a convenient solution for urban gardening, it also presents unique challenges in terms of protecting the plants as they grow upward. Makeshift barriers or wires may offer some level of protection, but they are often difficult to secure properly and may not be sufficient to guard against all potential threats.

Therefore, there exists a long-felt need in the art for a plant-protecting device. There also exists a long-felt need in the art for a plant-protecting pot device. More specifically, there exists a long-felt need in the art for a plant-protecting pot device that can house a plant and protect the plant while it grows. In addition, there exists a long-felt need in the art for a plant-protecting pot device that can house a plant and protect the plant while it grows wherein the device takes up minimal surface area.

The subject matter disclosed and claimed herein, in one embodiment thereof, comprises a plant-protecting pot device. The device is comprised of a plant-protecting pot device. The device is comprised of a pot that can be used to store a plant. The pot is comprised of a rim comprised of at least one fastener. At least one base of the device is comprised of at least one barrier that is generally conical. The base is comprised of at least one fastener that can be attached to the fastener of the rim. As a result, the barrier surrounds a plant within the pot while the plant grows. The barrier protects the plant from animals, weather, and other damage.

In this manner, the plant-protecting pot device of the present invention accomplishes all the forgoing objectives and provides a plant-protecting device. More specifically, the device can house a plant and protect the plant while it grows. In addition, because the protective barrier is attached to the pot, the device takes up minimal surface area.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a plant-protecting pot device. The device is comprised of at least one pot which can house at least one plant in an interior space of the pot. The pot may receive at least one removable barrier, wherein the barrier may be in the form of a wire material that encloses and protects the plant.

The body of the pot has at least one rim that surrounds the opening. The rim is preferably comprised of at least one fastener that receives a fastener of a base of a barrier. This allows the barrier to removably attach to the body. The fastener of the base and fastener of the rim may be any type of reciprocating fastener type known in the art that allows the base (and barrier attached to the base) to be removed or added to the body as necessary to protect a plant.

More specifically, the barrier is preferably conical in shape and is fixedly attached to the base. The barrier may be made of materials such as but not limited to wire. The barrier surrounds and protects a plant within the pot while it grows. Because the barrier attaches directly to the body of the pot, the barrier takes up no additional surface area on a ground surface, which is advantageous for gardening in a confined space.

The present invention is also comprised of a method of using the device. First, a device is provided comprised of a pot comprised of a rim with at least one fastener and a barrier comprised of at least one base comprised of at least one fastener. Then, a plant can be planted in the interior space of the body. Next, the base can be attached to the rim of the body such that the barrier surrounds and protects the plant. Further, the plant or certain portions of the plant may be tied or secured to various points of the barrier to encourage specific growing patterns.

The present invention is also comprised of a second method of using the device. First, a device is provided comprised of a pot comprised of a rim with at least one fastener and a barrier comprised of at least one base comprised of at least one fastener. Then, a plant can be planted in the interior space of the body. Next, the barrier can be attached to the base via at least one fastener. Then, the base can be attached to the rim of the body such that the barrier surrounds and protects the plant. Further, the plant or certain portions of the plant may be tied or secured to various points of the barrier to encourage specific growing patterns.

Accordingly, the plant-protecting pot device of the present invention is particularly advantageous as it provides a plant-protecting device. More specifically, the device can house a plant and protect the plant while it grows. In addition, because the protective barrier is attached to the pot, the device takes up minimal surface area. In this manner, the plant-protecting pot device overcomes the limitations of existing plant pots and protection methods known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a pot of one potential embodiment of a plant-protecting pot device of the present invention while a plant is planted inside the pot in accordance with the disclosed architecture;

FIG. 2 illustrates a perspective view of a pot (and barrier attached to the pot) of one potential embodiment of a plant-protecting pot device of the present invention while a plant is planted inside the pot in accordance with the disclosed architecture;

FIG. 3 illustrates a flowchart of a method of using one potential embodiment of a plant-protecting pot device of the present invention in accordance with the disclosed architecture; and

FIG. 4 illustrates a flowchart of a method of using one potential embodiment of a plant-protecting pot device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a plant-protecting device. There also exists a long-felt need in the art for a plant-protecting pot device. More specifically, there exists a long-felt need in the art for a plant-protecting pot device that can house a plant and protect the plant while it grows. In addition, there exists a long-felt need in the art for a plant-protecting pot device that can house a plant and protect the plant while it grows wherein the device takes up minimal surface area.

The present invention, in one exemplary embodiment, is comprised of a plant-protecting pot device comprised of at least one pot that can house at least one plant in an interior space of the pot. The pot may receive at least one removable barrier, wherein the barrier may be in the form of a wire material that encloses and protects the plant.

The body of the pot has at least one rim that surrounds the opening. The rim is preferably comprised of at least one fastener that receives a fastener of a base of a barrier to allow the barrier to removably attach to the body. The fastener of the base and fastener of the rim may be any type of reciprocating fastener type known in the art that allows the base (and barrier attached to the base) to be removed or added to the body as necessary to protect a plant.

More specifically, the barrier is preferably conical in shape and is fixedly attached to the base. The barrier may be made of materials such as but not limited to wire. The barrier surrounds and protects a plant within the pot while it grows. Because the barrier attaches directly to the body of the pot, the barrier takes up no additional surface area on a ground surface, which is advantageous for gardening in a confined space.

The present invention is also comprised of a method of using the device. First, a device is provided comprised of a pot comprised of a rim with at least one fastener and a barrier comprised of at least one base comprised of at least one fastener. Then, a plant can be planted in the interior space of the body. Next, the base can be attached to the rim of the body such that the barrier surrounds and protects the plant. Further, the plant or certain portions of the plant may be tied or secured to various points of the barrier to encourage specific growing patterns.

The present invention is also comprised of a second method of using the device. First, a device is provided comprised of a pot comprised of a rim with at least one fastener and a barrier comprised of at least one base comprised of at least one fastener. Then, a plant can be planted in the interior space of the body. Next, the barrier can be attached to the base via at least one fastener. Then, the base can be attached to the rim of the body such that the barrier surrounds and protects the plant. Further, the plant or certain portions of the plant may be tied or secured to various points of the barrier to encourage specific growing patterns.

Accordingly, the plant-protecting pot device of the present invention is particularly advantageous as it provides a plant-protecting device. More specifically, the device can house a plant and protect the plant while it grows. In addition, because the protective barrier is attached to the pot, the device takes up minimal surface area. In this manner, the plant-protecting pot device overcomes the limitations of existing plant pots and protection methods known in the art.

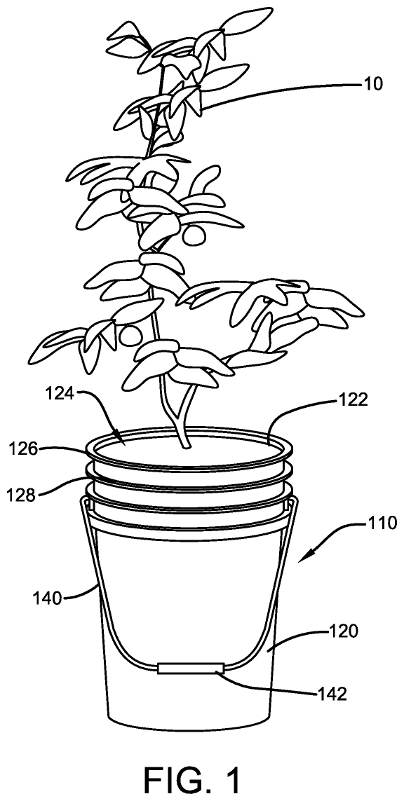

Referring initially to the drawings, FIG. 1 illustrates a perspective view of a pot of one potential embodiment of a plant-protecting pot device 100 of the present invention while a plant 10 is planted inside the pot 110 in accordance with the disclosed architecture. The device 100 is comprised of at least one pot 110 which can house at least one plant 10 in an interior space 124 of the pot 110. The pot 110 may receive at least one removable barrier 130, wherein the barrier 130 may be in the form of a wire material.

The pot 110 may have a body 120 of any plant pot or other plant-holding container known in the art. The body 120 may be any size, shape, or dimension. The body 120 has at least one opening 122 that allows at least one plant 10 to be planted within the interior space 124 of the body 120.

In order to allow the pot 110 to be easily moved, the pot 110 may be comprised of at least one handle 140. In one embodiment, the handle 140 is integrated (i.e., molded) into the body 120 of the pot 110. In another embodiment, the handle 140 extends from the body 120. The handle 140 may be comprised of at least one grip area 142. In one embodiment, the grip area 142 is comprised of a raised or a recessed texture to improve the grip of the handle 140.

The body 120 of the pot 110 has at least one rim 126 that surrounds the opening 122. The rim 126 is preferably comprised of at least one fastener 128. The fastener 128 of the rim 126 receives a fastener 134 of a base 132 of a barrier 130. This allows the barrier 130 to removably attach to the body 120.

The fastener 134 of the base 132 and fastener 128 of the rim 126 may be any type of reciprocating fastener type known in the art such as but not limited to male and female threads, tongue and groove, snap button, magnetic, etc. This allows the base 132 (and barrier 130 attached to the base 132) to be removed or added to the body 120 as necessary to protect a plant 10.

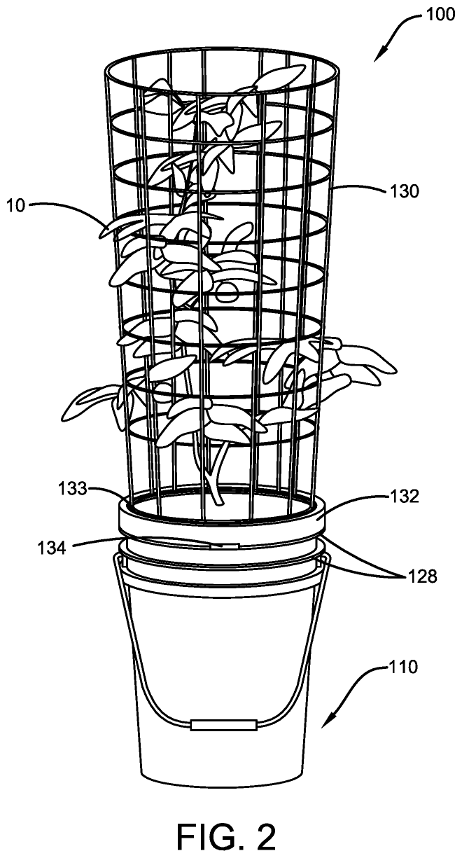

More specifically, the barrier 130 is preferably conical in shape and is fixedly attached to the base 132. The barrier 130 may be made of materials such as but not limited to chicken wire, wire, wire mesh, netting etc. of any spacing and thickness. In this manner, the barrier 130 surrounds and protects a plant 10 within the pot 110 while it grows from animals, weather, etc., as seen in FIG. 2. Because the barrier 130 attaches directly to the body 120 of the pot 110, the barrier 130 takes up no additional surface area on a ground surface, which is advantageous for gardening in a confined space. The barrier 130 may also be made from a plastic (and/or the same material as the pot 110) in one embodiment.

The device 100 may be any color known in the art. More specifically, the device 100 may be comprised of a color that attracts pollinating animals. Said colors include but are not limited to blue, purple, yellow, red, orange, pink, white, etc.

Further, the base 132 of the barrier 130 may be stackable on another base 132 of another barrier. In one embodiment, the barrier 130 may removably attach to the base 132 via at least one fastener 133 such as but not limited to screw, bolt, snap, tongue and groove, magnetic, etc. This allows the barrier 130 to be removed/replaced as needed during use, transport, storage, etc.

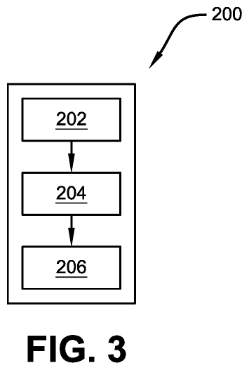

The present invention is also comprised of a method of using 200 the device 100, as seen in FIG. 3. First, a device 100 is provided comprised of a pot 110 comprised of a rim 126 with at least one fastener 128 and a barrier 130 comprised of at least one base 132 comprised of at least one fastener 134 [Step 202]. Then, a plant 10 can be planted in the interior space 124 of the body 120 [Step 204]. Next, the base 132 can be attached to the rim 126 of the body 120 such that the barrier 130 surrounds and protects the plant 10 [Step 204]. Further, the plant 10 or certain portions of the plant 10 may be tied or secured to various points of the barrier 130 to encourage specific growing patterns [Step 206].

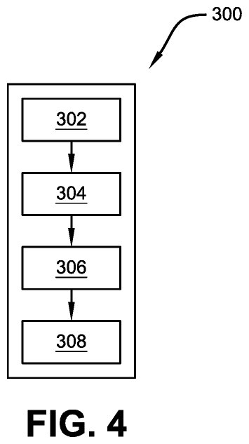

The present invention is also comprised of a second method of using 300 the device 100, as seen in FIG. 4. First, a device 100 is provided comprised of pot 110 comprised of a rim 126 with at least one fastener 128 and a barrier 130 comprised of at least one base 132 comprised of at least one fastener 134 [Step 302]. Then, a plant 10 can be planted in the interior space 124 of the body 120 [Step 304]. Next, the barrier 130 can be attached to the base 132 via at least one fastener 133 [Step 306]. Then, the base 132 can be attached to the rim 126 of the body 120 such that the barrier 130 surrounds and protects the plant 10 [Step 204]. Further, the plant 10 or certain portions of the plant 10 may be tied or secured to various points of the barrier 130 to encourage specific growing patterns [Step 308].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “plant-protecting pot device” and “device” are interchangeable and refer to the plant-protecting pot device 100 of the present invention.

Notwithstanding the forgoing, the plant-protecting pot device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the plant-protecting pot device 100 as shown in the FIGS. are for illustrative purposes only, and that many other sizes and shapes of the plant-protecting pot device 100 are well within the scope of the present disclosure. Although the dimensions of the plant-protecting pot device 100 are important design parameters for user convenience, the plant-protecting pot device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A plant-protecting pot device comprising:
a pot comprised of a first fastener; and
a barrier comprised of a base, the base comprised of a second fastener.

2. The plant-protecting pot device of claim 1, wherein the barrier is comprised of a wire material.

3. The plant-protecting pot device of claim 2, wherein the wire material is comprised of a chicken wire.

4. The plant-protecting pot device of claim 1, wherein the barrier is comprised of a wire mesh material.

5. The plant-protecting pot device of claim 1, wherein the barrier is comprised of a plastic material.

6. The plant-protecting pot device of claim 1, wherein the barrier is comprised of a conical shape.

7. The plant-protecting pot device of claim 1, wherein the first fastener is comprised of a male thread.

8. The plant-protecting pot device of claim 1, wherein the second fastener is comprised of a female thread.

9. A plant-protecting pot device comprising:
a pot comprised of a first fastener and a handle; and
a barrier comprised of a base, the base comprised of a second fastener.

10. The plant-protecting pot device of claim 9, wherein the handle is comprised of a grip area.

11. The plant-protecting pot device of claim 10, wherein the grip area is comprised of a raised or a recessed texture.

12. The plant-protecting pot device of claim 9, wherein pot, the barrier, and the base are comprised of a color.

13. The plant-protecting pot device of claim 9, wherein the base is comprised of a third fastener.

14. The plant-protecting pot device of claim 13, wherein the barrier attaches to the base via the third fastener.

15. The plant-protecting pot device of claim 9, wherein the first fastener is comprised of a male thread, a female thread, a tongue, a groove, a snap button, or a magnetic fastener.

16. The plant-protecting pot device of claim 9, wherein the second fastener is comprised of a male thread, a female thread, a tongue, a groove, a snap button, or a magnetic fastener.

17. A method of using a plant-protecting pot device, the method comprising:
providing a plant-protecting pot device comprised of a pot comprised of a first fastener and a barrier comprised of a base comprised of a second fastener;
planting a plant in an interior space of the pot; and
attaching the second fastener of the base to the first fastener of the pot such that the barrier surrounds the plant.

18. The method of using a plant-protecting pot device of claim 17, wherein the barrier is comprised of a wire material.

19. The method of using a plant-protecting pot device of claim 17, wherein the first fastener is comprised of a threaded fastener.

20. The method of using a plant-protecting pot device of claim 17, wherein the second fastener is comprised of a threaded fastener.
